(19) United States
(12) Patent Application Publication
(10) Pub. No.: US 2020/0101442 A1
(43) Pub. Date: Apr. 2, 2020

(54) EXHAUST GAS PURIFICATION FILTER AND METHOD OF MANUFACTURE THEREOF

(71) Applicant: DENSO CORPORATION, Kariya-city (JP)

(72) Inventor: Hiroaki KAYAMA, Kariya-city (JP)

(21) Appl. No.: 16/587,403

(22) Filed: Sep. 30, 2019

(30) Foreign Application Priority Data
Oct. 1, 2018 (JP) 2018-186312
Dec. 13, 2018 (JP) 2018-233555

(51) Int. Cl. B01J 21/16; F01N 3/022

(52) U.S. Cl. CPC B01J 21/16; F01N 2330/04; F01N 2330/06; F01N 3/0222

(57) ABSTRACT

An exhaust gas purification filter is provided which has a high capture ratio of particulate matter even when having a high porosity. The exhaust gas purification filter has a case, partition walls and cells. The partition walls are porous, and the interior of the case is partitioned into a plurality of the cells by the partition walls. The partition walls have a plurality of communicating pores which communicate between cells adjacent to respective partition walls. The degree of tortuosity L/T of the communicating pores satisfies L/T≥1.1, where T μm is the thickness of the partition walls and L μm is the average flow path length of the communicating pores. Furthermore the exhaust gas purification filter is manufactured using porous silica having a tapped bulk density that is no greater than a predetermined value.

### CROSS-REFERENCE TO RELATED APPLICATION

This application is based on and claims the benefit of priority from earlier Japanese Patent Application No. 2018-186312 filed Oct. 1, 2018 and Japanese Patent Application No. 2018-233555 filed Dec. 13, 2018, the descriptions of which are incorporated herein by references.

### BACKGROUND

### 1. Technical Field

The present disclosure relates to an exhaust gas purification filter and to a method of manufacture of the exhaust gas purification filter.

### 2. Related Art

The exhaust gas emitted from internal combustion engines such as diesel engines and gasoline engines, and from combustion devices such as boilers, contains particulate matter, designated in the following as “PM” for brevity, sometimes referred to as particulates. An exhaust gas purification filter is used to capture the PM in the exhaust gas.

An exhaust gas purification filter generally has a plurality of cells that are formed by being partitioned by porous partition walls, and sealing portions that seal one end of each cell.

### SUMMARY

The present disclosure provides an exhaust gas purification filter. One mode of the present disclosure is an exhaust gas purification filter having an outer casing, porous partition walls that partition the interior of the outer casing into a plurality of cells, and a plurality of communicating pores which communicate between cells that are adjacent to respective partition walls, and whereby, when the degree of tortuosity of the communicating pores is defined as the ratio of the average flow path length L μm of the communicating pores to the thickness T μm of the partition walls, the relationship of the following equation (1) is satisfied:

L/T≥1.1 (1)

The present disclosure provides a method of manufacturing an exhaust gas purification filter. One mode of the present disclosure is a method of manufacturing, including a mixing step of mixing porous silica having tapped bulk density of less than 0.38 g/cm3, talc, and an Al source (aluminum source), to produce a cordierite-forming raw material, a molding step of preparing a clay containing the cordierite forming raw material and molding the clay to form a molded body, and a firing step of firing the molded body.

### BRIEF DESCRIPTION OF THE DRAWINGS

In the accompanying drawings:

FIG. 1 is a perspective view of an exhaust gas purification filter according to a first embodiment;

FIG. 2 is an enlarged view of a partial cross section of the exhaust gas purification filter according to the first embodiment, taken in a plane parallel to the axial direction of the filter;

FIGS. 3A and 3B show examples of enlarged conceptual cross-sectional views of partition walls of an exhaust gas purification filter according to the first embodiment;

FIGS. 4A and 4B are conceptual cross-sectional views of partition walls showing the pores of FIGS. 3A and 3B respectively in simplified form;

FIG. 5 is an explanatory diagram concerning a CT scan of a partition wall in the first embodiment;

FIG. 6 is a diagram showing an example of a CT scan image of a partition wall in the first embodiment;

FIG. 7 is an enlarged view of the scan image shown in FIG. 6;

FIG. 8A is a diagram showing an example of a CT scan image of a partition wall in the first embodiment;

FIG. 8B is a diagram showing a binarized processed image of the CT scan image;

FIG. 9 is a diagram showing locations from which measurement samples were gathered from an exhaust gas purification filter according to the first embodiment, for use in measuring degrees of tortuosity;

FIG. 10 is an enlarged cross-sectional view of a partition wall according to a second embodiment, conceptually illustrating the positions of neck portions in communicating pores;

FIG. 11 is a CT scan image of a partition wall in the second embodiment, showing a position of a neck portion in a communicating pore;

FIG. 12 is a cross-sectional view of a neck diameter measuring jig having a test body set therein, with a first experimental example;

FIG. 13 shows pressure curves expressing relationships between pressure and flow rate, with the first experimental example;

FIG. 14 is a graph showing a relationship between neck diameter and frequency, with the first experimental example;

FIG. 15 is a graph showing a relationship between degree of tortuosity and capture ratio, with the first experimental example;

FIG. 16 is a graph showing a relationship between degree of tortuosity and pressure loss, with the first experimental example;

FIG. 17 is a graph showing a relationship between the ratio average neck diameter Φ₁/average pore diameter Φ₂ and the capture ratio, with the first experimental example;

FIG. 18 is a graph showing a relationship between the ratio average neck diameter Φ₁/average pore diameter Φ₂ and pressure loss, with the first experimental example;

FIG. 19 is a graph showing a relationship between the tapped bulk density TD_{S} of porous silica and the capture ratio, with a second experimental example;

FIG. 20 is a graph showing the relationship between the capture ratio and the ratio PD_{M}/TD_{ST} of the compressed bulk density PD_{M} g/cm³ of cordierite-forming raw material to the tapped bulk density TD_{ST} g/cm³ of a mixed powder of porous silica and talc, with the second experimental example; and

FIG. 21 is a diagram showing the relationship between the capture ratio and the ratio A₁/A₂ of the average particle size A₁ of porous silica to the average particle size A₂ of aluminum hydroxide, with the second experimental example.

### DETAILED DESCRIPTION OF THE PREFERRED EMBODIMENTS

The inventor of the present disclosure has studied the following technique related to an exhaust gas purification filter having a casing, porous partition walls that partition the interior of the casing, and cells that are surrounded by the partition walls.

An exhaust gas purification filter generally has a plurality of cells that are formed by being partitioned by porous partition walls, and sealing portions that seal one end of each cell. There is a requirement to reduce the loss of pressure that results from an exhaust gas purification filter, while increasing the capture ratio of PM. In the following the capture ratio of PM is referred to simply as the “capture ratio”, and the loss of pressure due to the filter is referred to as the “pressure loss”. Increasing the porosity of the partition walls is effective for decreasing the pressure loss. However when the porosity is increased, the capture ratio tends to decrease.

In recent years attempts have been made to improve the capture ratio, while increasing the porosity, by defining the internal structure of the porous partition walls. For example Japanese Unexamined Patent Application Publication No. 2017-164691 (JP-2017-164691-A), referred to in the following as PTL1, discloses a technology for increasing the network length of a network that is obtained by thinning a 3D model of a ceramic portion of a honeycomb wall. According PTL1, the form of the honeycomb wall can be made complex by adopting this configuration, and although the porosity is increased thereby, particles such as soot can be captured with high efficiency.

However, PM is mainly captured when it passes through pores that connect between partition walls. Hence, a pore structure that is effective for PM collection is one in which there are communicating pores, which extend from the gas inlet side to the gas outlet side of respective partition walls. However the configurations of the pores in the network structure of the ceramic part of an exhaust gas purification filter do not necessarily correspond sufficiently to this structure. The technology of lengthening the network of the ceramic part, described in PTL 1, does not sufficiently modify the structure of the communicating pores in which the PM is collected. That is, even if the network length of the ceramic portion is increased, the configuration of the communicating pores through which the PM passes is not necessarily made more complex, and hence there is a limit to the improvement in the capture ratio which can be achieved by this technology.

The present disclosure is intended to overcome the above problem, by providing an exhaust gas purification filter whereby PM can be collected with a high capture ratio even when the porosity of the filter is raised.

According to a first mode the present disclosure provides an exhaust gas purification filter having an outer casing, porous partition walls that partition the interior of the outer casing into a plurality of cells, and a plurality of communicating pores which communicate between cells that are adjacent to respective partition walls, and whereby, when the degree of tortuosity of the communicating pores is defined as the ratio of the average flow path length L μm of the communicating pores to the thickness T μm of the partition walls, the relationship of the following equation (1) is satisfied:

L/T≥1.1 (1)

According to another mode, the present disclosure provides a method of manufacturing an exhaust gas purification filter, comprising a mixing step of mixing porous silica having tapped bulk density of less than 0.38 g/cm³, talc, and an Al source (aluminum source), to produce a cordierite-forming raw material, a molding step of preparing a clay containing the cordierite forming raw material and molding the clay to form a molded body, and a firing step of firing the molded body.

The above exhaust gas purification filter having the configuration of a casing, cells and communicating pores has a degree of tortuosity L/T of the communicating pores that is defined by the ratio of the average flow path length L μm of the communicating pores to the thickness T μm of the partition walls, where the degree of tortuosity L/T satisfies equation (1) above. That is, the average flow path length is formed such as to be at least 1.1 times the thickness T μm of the partition walls. Such a configuration of the partition walls is effective for rendering the communicating pores tortuous.

The capture ratio of an exhaust gas purification filter depends on the frequency of collisions of PM with the partition walls. By setting the degree of tortuosity to at least 1.1, the structure of the communicating pores through which the PM passes becomes complex, and this leads to an increase in the frequency of collisions of PM with the partition walls. That is, it can be considered that the frequency of inertial collisions of PM is increased due to the tortuosity of the communicating pores. As a result, the exhaust gas purification filter can exhibit a high capture ratio even if the porosity is increased.

The above method of manufacturing the exhaust gas purification filter has a mixing step, a forming step and a firing step. In the mixing step, porous silica, talc and an Al source are mixed to produce a cordierite-forming raw material. In the forming step, a clay containing the cordierite-forming raw material is prepared, and the clay is molded to produce a molded body. In the firing step, the molded body is fired, thereby obtaining the exhaust gas purification filter.

Porous silica having a tapped bulk density of 0.38 g/cm³ or less is used in the mixing step. The proportion by volume which porous silica occupies in the cordierite formation raw material can be thereby increased. As a result, the degree of tortuosity L/T of the communicating pores is increased, enabling an exhaust gas purification filter that satisfies the relationship L/T≥1.1, for example, to be manufactured. An exhaust gas purification filter having a high capture ratio can thereby be obtained.

It should be noted that numerals in parentheses appearing in the appended claims and in the following description serve to show correspondence relationships for elements of embodiments that are described hereinafter, and do not limit the technical scope of the present disclosure.

The above and other objectives, features and advantages of the present disclosure will be made more clear by the following detailed description, given referring to the appended drawings.

Hereinafter, embodiments of the present disclosure will be described with reference to the drawings.

### First Embodiment

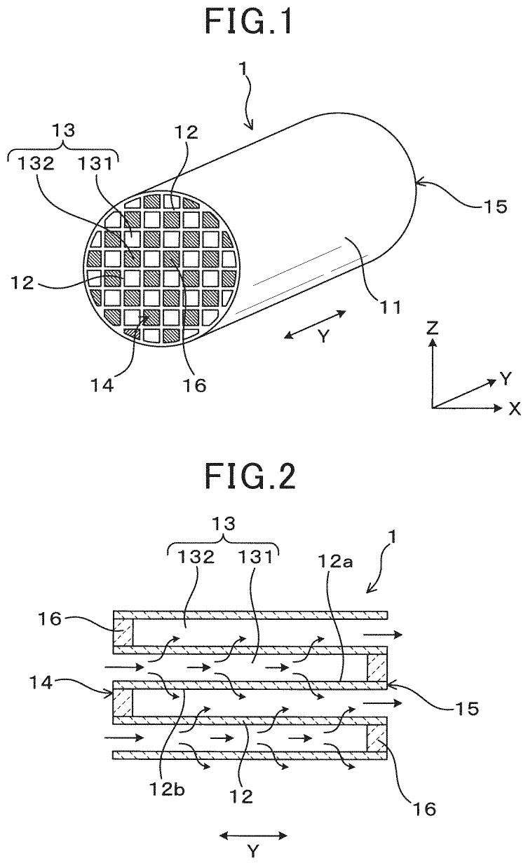

An embodiment of an exhaust gas purification filter will be described referring to FIGS. 1 to 9. As illustrated in FIGS. 1 to 3, the exhaust gas purification filter 1 of this embodiment, which is formed of cordierite etc., has a casing 11, partition walls 12, and cells 13. The casing 11 of the present embodiment has a cylindrical shape, with the axial direction of the casing 11 being designated as the axial direction Y. The arrows in FIG. 2 show the paths through which exhaust gas flows, when the exhaust gas purification filter is disposed for passing exhaust gas from an exhaust pipe, etc.

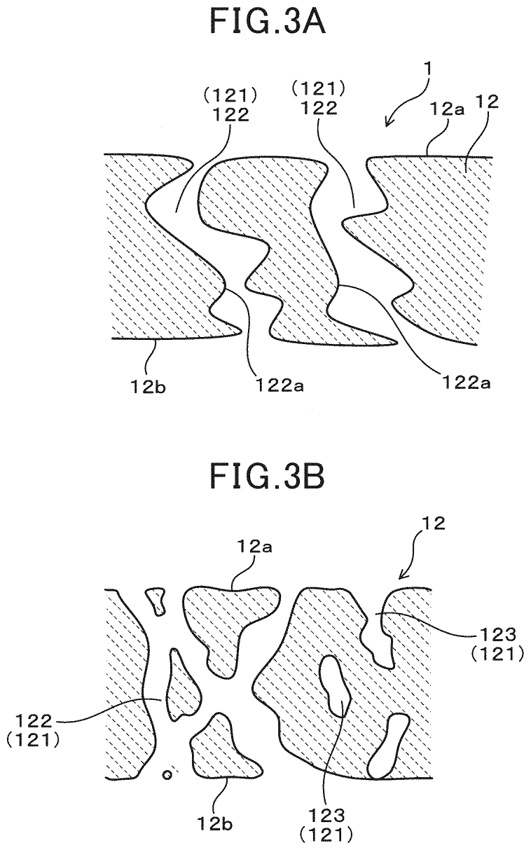

As illustrated in FIGS. 1 and 2, the partition walls 12 divide the interior of the casing 11 into a large number of cells 13. Such partition walls 12 are sometimes referred to as cell walls. The partition walls 12 of this embodiment are formed in a lattice configuration. The exhaust gas purification filter 1 has a porous body, with a plurality of pores 121 formed in the partition walls 12 as illustrated in FIGS. 3A and 3B, so that PM contained in the exhaust gas is captured and deposited on the surfaces of the partition walls 12 and in the interiors of the pores 121. The PM consists of fine particles, referred to as particulate matter or particulates, etc.

The average pore diameter of the partition walls 12 can be adjusted within a range of 12 μm to 30 μm, preferably 13 μm to 28 μm, and more preferably 15 μm to 25 μm. The porosity of the partition walls 12 can be adjusted within a range of 55% to 75%, preferably 58% to 73%, and more preferably 60% to 70%. If the average pore diameter and the porosity of the partition walls 12 are within these ranges, a requisite degree of strength can be ensured while achieving both a high capture ratio and a low degree of pressure loss. If the average pore diameter of the partition walls 12 is 12 μm or more and the porosity is 55% or more, Darcy's permeability coefficient can be increased to, for example, 0.8 or more, and a sufficiently low degree of pressure loss can be achieved. As a result, the exhaust gas purification filter 1 is suitable for applications such as capturing PM discharged from a gasoline engine. If the average pore diameter of the partition walls 12 is 30 μm or less, the degree of tortuosity of the communicating pores 122, described hereinafter, can be readily increased, and the capture ratio can be further enhanced. If the porosity of the partition walls 12 is 75% or less, the structural reliability of the exhaust gas purification filter 1 can be readily ensured. The average pore size and porosity of the partition walls 12 can be measured by mercury porosimetry, as described hereinafter for experimental examples.

As illustrated in FIGS. 1 and 2, the exhaust gas purification filter 1 has a large number of cells 13. The cells 13 are surrounded by the partition walls 12, to form gas flow paths. The extension direction of a cell 13 generally coincides with the axial direction Y.

As illustrated in FIG. 1, the cell shape, as seen in cross-sectional view taken orthogonal to the axial direction Y, may be rectangular. However the cell shape is not limited to this, and may be a polygon such as a triangle, a quadrilateral, or a hexagon, or may be a circle, or a combination of two or more different shapes.

The exhaust gas purification filter 1 of this embodiment is a columnar body having a cylindrical shape, whose dimensions can be changed as required. The exhaust gas purification filter 1 has a first end surface 14 and second end surface 15, located at respectively opposite ends with respect to the axial direction Y. When the exhaust gas purification filter 1 is disposed in an exhaust gas passage such as an exhaust pipe, the first end surface 14 constitutes an upstream end surface while the second end surface 15 constitutes a downstream end surface.

The cells 13 comprise first cells 131 and second cells 132. As illustrated in FIG. 2, each first cell 131 is open at the first end surface 14 and is closed by a sealing portion 16 at the second end surface 15. Each second cell 132 is open at the second end surface 15 and is closed by a sealing portion 16 at the first end surface 14. The sealing portions 16 can be made of a ceramic such as cordierite, but may be made of other materials. Although the sealing portions 16 shown in FIG. 2 are in the shape of plugs, the shape not particularly limited, so as long as cells can be sealed at the first end surface 14 and second end surface 15. In addition, although illustration of such a structure is omitted, it would be also possible to form the sealing portions 16 by deforming parts of the partition walls 12 at the first end surfaces 14 and end surfaces 15. In this case, since the sealing portions 16 would be constituted by parts of the partition walls 12, the partition walls 12 and the sealing portion 16 would be formed continuously.

The first cells 131 and second cells 132 of this embodiment are formed such as to be arranged alternately adjacent to each other, with respect to a lateral direction orthogonal to the axial direction Y and also with respect to a longitudinal direction orthogonal to both the axial direction Y and the lateral direction. That is, when the first end surface 14 or the second end surface 15 of the exhaust gas purification filter 1 is viewed from the axial direction Y, the first cells 131 or the second cells 132 are arrayed in a checkerboard pattern.

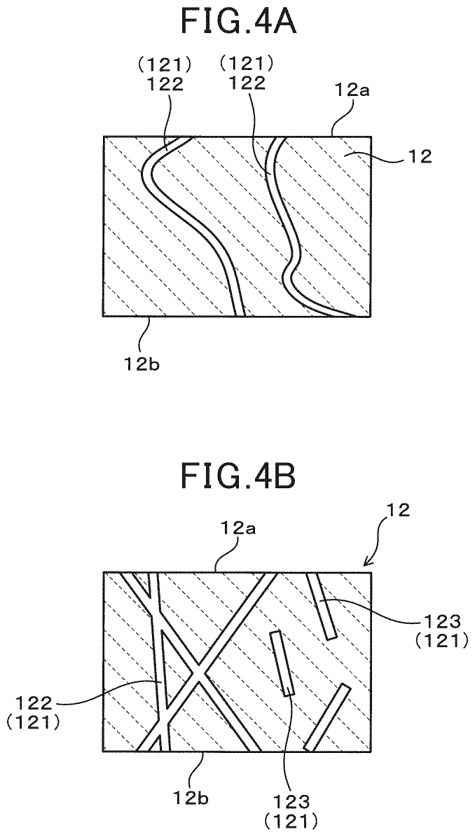

The partition walls 12 separate first cells 131 and second cell 132 that are adjacent to each other, as illustrated in FIG. 2. A large number of pores 121 are formed in the partition walls 12 as illustrated in FIGS. 3A and 3B. As shown, in addition to communicating pores 122 that communicate between first cells 131 and second cells 132 which are adjacent to each other, the partition walls 12 also contain non-communicating pores 123 that do not allow communication between a first cell 131 and a second cell 132. FIGS. 4A and 4B show the pores 121 of FIGS. 3A and 3B in more simplified form. Although in FIGS. 3 and 4 the pores 121 are shown in two-dimensional form for simplicity, it can be considered that, at least in the case of the communicating pores 122, most of the pores intersect in three dimensions.

In the exhaust gas purification filter 1 of the present embodiment, the degree of tortuosity of the communicating pores 122 is 1.1 or more. The degree of tortuosity is defined as the ratio of the average flow path length L μm of the communicating pores 122 to the thickness T μm of the partition walls 12, i.e., is expressed by L/T. If the degree of tortuosity is 1.1 or more, the exhaust gas purification filter 1 can exhibit a high capture ratio even if the porosity is made high. Specifically, the exhaust gas purification filter 1 can exhibit a sufficiently high capture ratio even if the porosity is increased to 55% or more, for example. Hence the capture ratio can be increased while suppressing an increase in pressure loss.

From the aspect of enhancing the capture ratio, the degree of tortuosity is preferably 1.15 or more, more preferably 1.2 or more, and still more preferably 1.3 or more, or even more preferably 1.35 or more. On the other hand since, if the degree of tortuosity is made excessively high the capture ratio gradually becomes more difficult to improve, and it becomes more difficult to reduce the pressure loss. Hence from the aspect of restraining the pressure loss, the degree of tortuosity is preferably set to 1.6 or less, or more preferably 1.5 or less, or even more preferably 1.4 or less. From the aspect of achieving both a high capture ratio and a low amount of pressure loss, it is more preferable to set the degree of tortuosity within a range of 1.2 to 1.3.

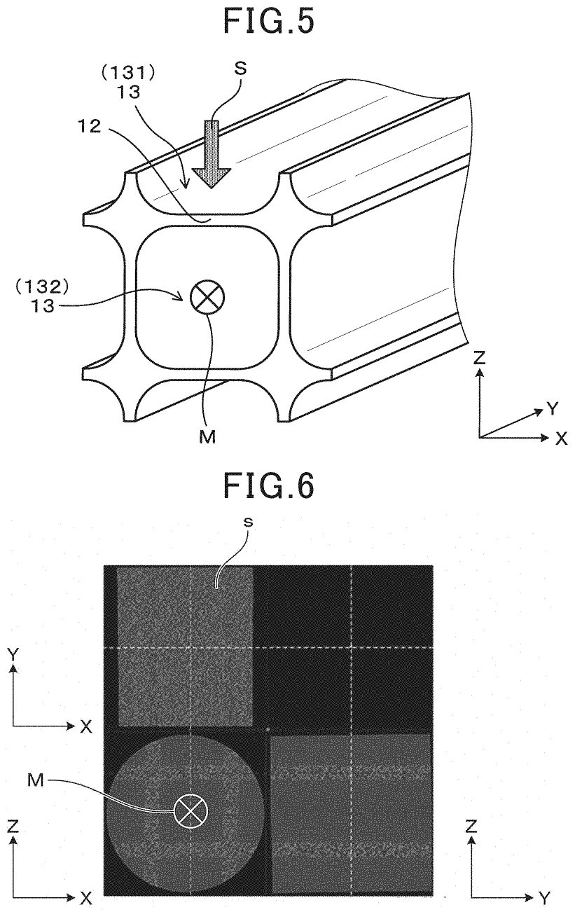

The degree of tortuosity was measured as follows. Specifically, as illustrated in FIG. 5, a CT scan was performed of the partition walls 12 of a measurement sample that had been collected from an exhaust gas purification filter, to capture a scan image of the walls 12. An Xradia 520 Versa, manufactured by the ZEISS company was used as the CT scanning apparatus. The measurement conditions were a tube voltage of 80 kV and a tube current of 87 mA. The resolution of the captured image is 1.6 μm/pixel. Note that FIG. 5 shows a part of the measurement sample.

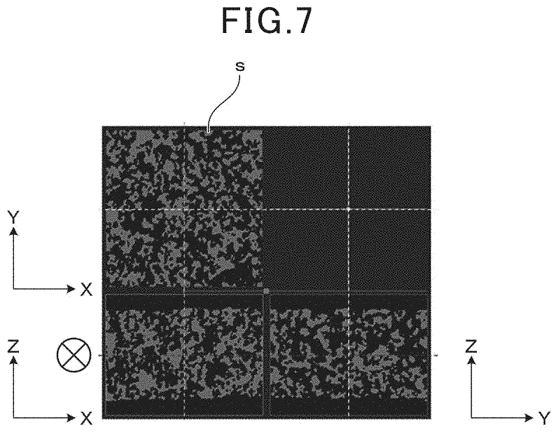

The scanning direction S of the CT scan was along the thickness direction of a partition wall 12, from a surface of the partition wall 12 (referred to as partition wall surface 12a for convenience in the following) which is on the side of a first cell 131, toward the surface of that partition wall 12 (referred to in the following as partition wall surface 12b) which is at the side of a second cell 132, where the first cell 131 opens at the first end surface 14 (which is the upstream side end surface) and the second cell 132 opens at the second end surface 15 (which is the downstream end surface). FIGS. 6 and 7 show examples of scan images, where FIG. 7 is an enlarged view of FIG. 7. In FIGS. 6 and 7, the direction along the Y axis is taken as the Y direction, and the direction at right angles to the Y direction and along one of the four partition walls 12 surrounding the second cell 132 is taken as the X direction, while the other direction at right angles to the Y direction is taken as the Z direction. The symbol M designates a sealing portion 16 that is on the first end surface 14.

Hence in FIGS. 6 and 7, the scan direction S is the −Z direction. The upper left images in FIGS. 6 and 7 show respective examples of scan images taken in this direction. A scan image that has been taken in the −Z direction is in an XY plane. For reference, scan images taken in the Y direction (images in an XZ plane) are shown on the lower left parts of FIGS. 6 and 7 respectively, and scan images taken in the −X direction (images in a YZ plane) are shown in the lower right parts of FIGS. 6 and 7 respectively.

Next, analysis was performed using a group of captured images taken in the scan direction S, where the number of images captured in scan direction S is equal to the thickness of a partition wall 12 (in μm) divided by the size of 1 pixel (1.6 μm). In the following example, the range of analysis image size in the XY plane is 500 μm×500 μm, while the number of images used for the −Z direction is equal to the thickness of a partition wall 12 (in μm) divided by 1.6 μm.

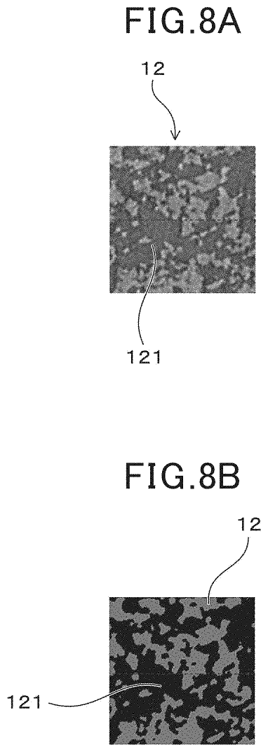

Binarization processing was then performed on the captured images taken in scan direction S. Image J analysis software manufactured by the United States National Institute of Health (NIH)) was used for the binarization processing. The purpose of the binarization is to distinguish between the pore portions and frame portions in the partition walls 12. A frame portion is a ceramic portion in the partition wall 12, while a pore portion is a portion other than a ceramic portion, i.e., in which there is no ceramic. Since the pore portions and frame portions have mutually different brightnesses, the binarization processing is performed after noise remaining in the captured images has been removed and an arbitrary threshold has been set. Since the appropriate threshold varies depending on each measurement sample, a threshold that is capable of separating the pore portions and the frame portions is set for each image, by visually checking the entire image captured by the CT scan. FIG. 8A shows an example of a captured image before the binarization process, and FIG. 8B shows an example after the binarization process. The black areas in FIG. 8B are the pore portions and the gray areas are the frame portions.

After the binarization processing, the captured image was read into GeoDict analysis software, manufactured by the SCSK company, and a virtual model was created in which the structure of the pore portions and the frame portions was modeled three-dimensionally under a condition of 0.685 μm per voxel. The flow path lengths (μm) of all of the communicating pores 122 were then measured for the virtual model that was obtained. The PM flows together with the gas, which tries to pass as a fluid through the shortest flow paths in the communicating pores 122. The flow paths lengths which were measured as above are the shortest paths through which the gas flows via the communicating pores 122. That is, the flow path length of a communicating pore 122 is a parameter that does not necessarily match the lengths of lines that connect the mid points of diameters of the pore. The average value of all of the obtained flow path lengths of the communicating pores 122 was taken as the average flow path length L μm of the communicating pores 122. Furthermore the thickness (μm) of the virtual model was set as the thickness T μm of the partition wall 12 at when calculating the degree of tortuosity. The degree of tortuosity of the measurement sample was then calculated by dividing the average flow path length L μm of the communicating pores 122, determined as described above, by the thickness T μm of the partition wall 12. Six measurement samples were collected from the exhaust gas purification filter 1, and the degree of tortuosity in the exhaust gas purification filter 1 was calculated as the average value of the respective degrees of tortuosity of the measurement samples, calculated as described above.

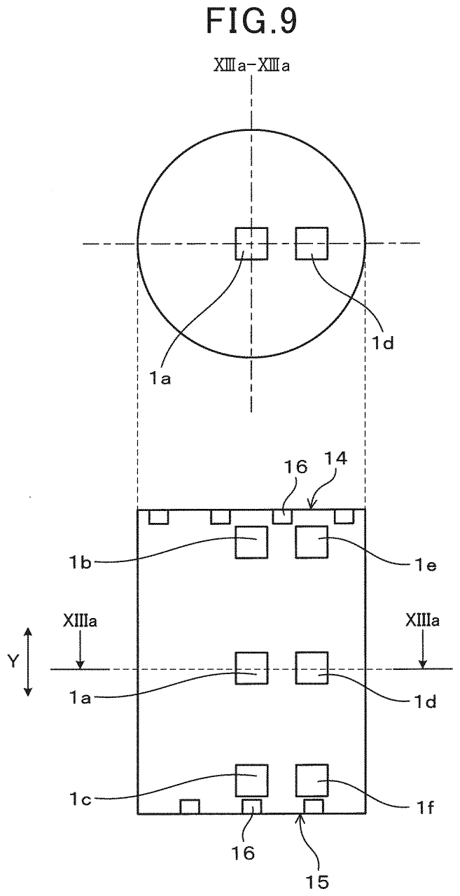

Specifically, as shown in FIG. 9, the measurement samples were respectively collected from six locations, i.e., a central portion 1a, an inner-side portion 1b, an inner-side portion 1c, a central portion 1d, an inner-side portion 1e, and an inner-side portion 1f. The central portion 1a is at the center of a Y-direction axis that is along the central axis of the exhaust gas purification filter 1, the inner-side portion 1b is close behind the sealing portions 16 at the first end surface 14 of the filter, the inner-side portion 1c is close behind the sealing portions 16 at the second end surface 15 of the filter, the central portion 1d is at the center of a Y-direction axis that passes through the center of a radius of the filter, the inner-side portion 1e is close behind the sealing portions 16 at the first end surface 14 of the filter, and the inner-side portion if is close behind the sealing portions 16 at the second end surface 15 of the filter. The shape of each measurement sample is a cube, whose dimensions in the directions orthogonal to the axial direction Y are 5 mm long×5 mm wide and whose length in the axial direction Y is 5 mm.

The thickness of the partition walls 12 in the exhaust gas purification filter 1 can be adjusted, for example, in the range of 100 μm to 400 μm. As illustrated in FIG. 9, the thickness of the partition walls 12 was taken as the average of respective values of thickness measured at three of the above-described locations in the exhaust gas purification filter 1, i.e., at the central portion 1a, the inner-side portion 1b, and the inner-side portion 1c.

The capture ratio generally depends on the frequency of collisions of PM with the partition walls 12. By setting the degree of tortuosity L/T to 1.1 or more, as with the present embodiment, a complex structure is realized for the communicating pores 122 through which PM passes. As a result, the collision frequency of PM in the communicating pores 122 is increased. This is considered to be due to the fact that the frequency of inertial collisions of PM is increased by the tortuosity of the communicating pores 122. As a result, the exhaust gas purification filter 1 can exhibit a high capture ratio, even if the porosity is increased. The relationship between the degree of tortuosity and the capture ratio will be described in more detail with respect to a first experimental example, described hereinafter.

The capture ratio of the exhaust gas purification filter 1 of the present embodiment can be increased to, for example, 70% or more, while maintaining structural strength. A catalyst can be supported by coating the exhaust gas purification filter 1 with a slurry containing a catalyst such as a noble metal. When this is done, then depending on the catalyst particle diameter, slurry viscosity, supported amount, and flow rate conditions of the slurry at the time of coating, etc., part of the pores 121 become blocked and the capture ratio becomes lowered. In particular, if the supported amount is no greater than 70 g/L, the capture ratio becomes reduced to about ⅘ of the ratio before supporting, while if the supported amount is greater than 70 g/L, then the capture ratio becomes reduced to about ⅔˜½ of the ratio before supporting, and tends to become even lower. This is because the flow paths through those communicating pores 122 that are effective for PM collection become blocked by the catalyst.

It is preferable that the PM capture ratio after supporting the catalyst is more than 60%, from the aspect of responding to future strengthening of regulations. Hence, the PM capture ratio before supporting the catalyst is preferably 70% or more. Furthermore, from the aspect of responding to further strengthening of regulations, it is even more preferable that the PM capture ratio before supporting the catalyst is 80% or more. A catalyst supporting of 50 g/L or more can be applied to the exhaust gas purification filter 1, and the degree of tortuosity L/T in the condition in which that catalyst has been supported can be made greater than 1.6 and less than 2.5. An exhaust gas purification filter is often used in a state in which a catalyst has been supported, and it is important to maintain a sufficient degree of tortuosity of the communicating pores 122 in the partition walls 12 even with the filter in this condition. A catalyst amount of 50 g/L is necessary to satisfy future emission regulations. With the above configuration, the capture ratio can be improved and the pressure loss suppressed even in the state in which a catalyst has been supported. It should be noted that the degree of tortuosity L/T can also be determined by using the above-described method, in the condition in which a catalyst has been supported. In this condition, the degree of tortuosity is preferably made 1.7 or more, more preferably 1.8 or more, or even more preferably 2.0 or more, from the aspects of improvement in capture ratio and suppression of pressure loss, etc. In addition, the degree of tortuosity, in the state in which the catalyst has been supported, is preferably made 2.45 or less, more preferably 2.4 or less, or even more preferably 2.3 or less. The reason for a change in the degree of tortuosity after the catalyst becomes supported is that flow paths become blocked by the catalyst, so that the shortest flow paths which were formed before the catalyst was supported can no longer be taken.

### Second Embodiment

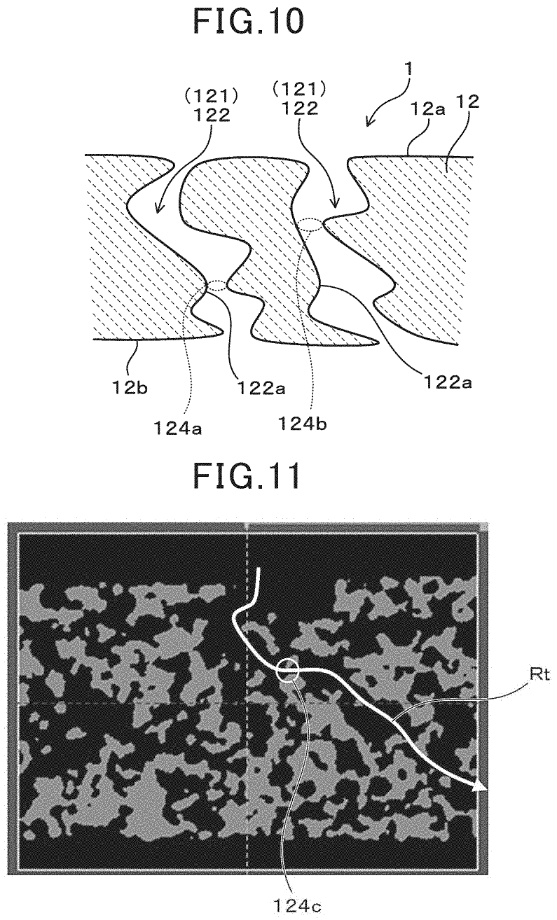

An exhaust gas purification filter according to a second embodiment will be described referring to FIGS. 1 to 9, used hereinabove in describing the first embodiment, and FIGS. 10 and 11. Where elements of the second embodiment correspond to elements of the first embodiment, identical reference numeral to those of the first embodiment are used in describing the second embodiment, unless otherwise indicated, and further description of these is omitted

In the exhaust gas purification filter 1 of the present embodiment, the relationship between the average value 11 μm of the neck diameter of the communicating pores 122 and the average pore diameter Φ₂ μm of the pores in the partition wall 12 satisfies the relationship of equation (3) below. The average value Φ₁ of the neck diameter is hereinafter to as the “average neck diameter Φ₁” in the following. That is, with the exhaust gas purification filter 1 of the present embodiment, the ratio Φ₁/Φ₂ of the average neck diameter Φ₁ to the average pore diameter Φ₂ of the partition wall 12 is 0.2 or more.

Φ₁/Φ₂≥0.2 (3)

First, the neck diameter will be described. As illustrated in FIG. 10, a large number of pores 121 are formed in a partition wall 12, including a large number of communicating pores 122 that communicate between adjacent ones of the cells 13. The flow passage area through which the exhaust gas flows in a communicating pore 122 is usually not constant, but varies continuously, and there are narrow portions in which the flow passage area decreases locally. In each communicating pore 122, the smallest narrow portions are neck portions 124a, 124b.

FIG. 11 is an image obtained by executing a CT scan on a partition wall 12 of the exhaust gas purification filter 1, in the same manner as for the first embodiment, and applying binarization processing. In FIG. 11, in a flow path Rt of the communicating pores 122 that is indicated by an arrow, the narrowest neck portion 124c is shown surrounded by a circular frame. The equivalent circular diameter of the flow passage area of the neck portion is the neck diameter. That is, the diameter of a circle having the same area as the flow passage area at the neck portion is the neck diameter. The neck diameter is defined by the equivalent circular diameter of the neck portion at which the flow passage area of the communicating pore 122 is a minimum. Although the flow path Rt indicated by the arrow in FIG. 11 finishes at the side of the scan image, the path actually continues from the partition wall front surface 12a to the partition wall back surface 12b.

The neck diameter was measured by the bubble point method. In this method, first, a porous measurement sample is completely impregnated with a liquid having a known surface tension. Pressure is then applied to the measurement sample, from one end surface of the sample. As the pressure is increased, the liquid in the pores of the measurement sample is pushed out, and the gas starts to flow through the sample. As the pressure increases, the gas flow rate increases. The pore diameter is calculated using equation (4) below, based on the pressure at which the gas flows from the end surface that is opposite the end surface to which the pressure is applied. In Equation (4), D_{P} is the pore diameter, γ is the surface tension of the liquid to be impregnated, and θ is the contact angle of the liquid, which is a constant. The measurement apparatus used with the present embodiment was the CEP-1100AXSHJ manufactured by the Porous Material company, and Silwick (surface tension: 20.1 [dyne/cm]), manufactured by the same company, was used as a reagent.

D_{P}=4×γ×cos θ×α/P (4)

With the present embodiment, the measurement sample used in the bubble point method is a part of an exhaust gas purification filter. Due to the fact that the measurement sample has a large number of communicating pores 122, the pressure at which gas flows out from the end surface in the bubble point method is limited by narrow portions in the communicating pores 122 (specifically, neck portions 124a, 124b, 124c). This is because the neck portions 124a, 124b, 124c in the communicating pores 122 predominantly determine the value of resistance to the gas flow. For this reason, the pore diameter D_{P} in Equation (4) is the neck diameter.

In the bubble point method, six measurement samples collected from an exhaust gas purification filter 1 were used. The respective collection locations of these measurement sample were the same as for the samples used in measurement of the degree of tortuosity, described hereinabove for the first embodiment. However the shape of a measurement sample with the bubble point method is that of a disc-shaped body having a diameter Φ of 19 mm in a direction orthogonal to the axial direction Y and a thickness of 400 μm to 500 μm along the axial direction Y. The end surfaces which change the pressure are disc surfaces of the disc-shaped body. Furthermore, no sealing portions 16 were included in the collected measurement samples. For this reason, sealing portions 16 were provided in the first cells 131 and the second cells 132 of each measurement sample, in order to have the same gas flow as in the exhaust gas purification filter 1. The neck diameter was measured by the bubble point method, using the six measurement samples, and the average value of the respective measured diameters was calculated as the average neck diameter Φ₁. Details are described hereinafter, for experimental examples.

The average pore diameter Φ₂ in the partition walls 12 was determined by the mercury intrusion method, as shown in the following experimental example.

The measurement sample was a rectangular solid whose dimensions in the directions orthogonal to the axial direction Y of the exhaust gas purification filter 1 are 15 mm long×15 mm wide, and the length in the axial direction Y is 20 mm.

When the average neck diameter Φ₁ μm and the average pore diameter Φ₂ μm measured as described above satisfy the relationship Φ₁/Φ₂≥0.2, the pressure loss of the exhaust gas purification filter 1 is decreased. To further reduce the pressure loss, it is preferable to satisfy the relationship Φ₁/Φ₂≥0.3, more preferable to satisfy the relationship Φ₁/Φ₂≥0.4, or even more preferable to satisfy the relationship Φ₁/Φ₂≥0.5.

Other configurations and operational effects are similar to those of the exhaust gas purification filter 1 of the first embodiment. An exhaust gas purification filter 1 having a high capture ratio and a low pressure loss can be provided by combining the configurations of the first embodiment and the second embodiment.

### Third Embodiment

A method of manufacturing an exhaust gas purification filter in which the pores have a degree of tortuosity of 1.1 or more, as with the first embodiment, will next be described. The exhaust gas purification filter of the present embodiment has cordierite as a main constituent, and is manufactured by performing a mixing step, a forming step, and a firing step as follows.

In the mixing step, porous silica, talc and an Al source (aluminum source) are mixed to produce a cordierite-forming raw material. In the forming step, a clay containing the cordierite-forming raw material is produced, and the clay is molded to produce a molded body. In the firing step, the molded body is fired.

The exhaust gas purification filter 1 has, as its main constituents, cordierite having a chemical composition of, for example, 45 wt % to 55 wt % by weight of SiO₂, 33 wt % to 42 wt % by weight of Al₂O₃, and 12 wt % to 18 wt % by weight of MgO. Hence in the manufacture of the exhaust gas purification filter 1, a cordierite forming raw material that includes a Si source, an Al source, and an Mg source are used in producing a cordierite composition.

A cordierite-forming raw material is a material capable of producing a cordierite composition by firing. With this embodiment, a mixture obtained by appropriately mixing silica, talc, aluminum hydroxide, alumina, kaolin, etc., is used as the raw material.

Porous silica having a tapped bulk density of less than 0.38 g/cm³ is used as the silica, thereby enabling an exhaust gas purification filter 1 having a degree of tortuosity of 1.1 or more to be obtained. The reason is as follows.

In a cordierite-forming raw material, porous silica and talc are pore-forming materials. By using porous silica having a tapped bulk density that is predetermined to be less than the above value, the proportion by volume of pore-forming material in the cordierite-forming raw material is increased. As a result, the number of communicating pores is increased, and the degree of tortuosity is increased, thereby enabling an exhaust gas purification filter 1 having a high capture ratio to be obtained. The tapped bulk density is measured by a method described hereinafter, with reference to an experimental example.

From the aspect of further increasing the degree of tortuosity and obtaining an exhaust gas purification filter 1 having an even higher capture ratio, the tapped bulk density TD_{S} of the porous silica is preferably made less than 0.38 g/cm³, or more preferably less than 0.33 g/cm³, and even more preferably less than 0.28 g/cm³.

Furthermore the compressed bulk density PD_{M} g/cm³ of the cordierite forming raw material and the tapped bulk density TD_{ST} g/cm³ of the mixed powder of porous silica and talc preferably satisfy the relationship PD_{M}/TD_{ST}≥1.7, or more preferably PD_{M}/TD_{ST}≥1.8, or even more preferably PD_{M}/TD_{ST}≥1.9. In this case, the degree of tortuosity L/T can be further increased. It can be considered that this is because the volumes of porous silica and talc in the cordierite-forming raw material can be increased by setting PD_{M}/TD_{ST} to one of the above predetermined values or higher.

The degree of tortuosity can not only be increased by increasing the tapped bulk density TD_{S} of porous silica, but also by making the ratio PD_{M}/TD_{ST} between the compressed bulk density PD_{M} g/cm³ of the cordierite forming raw material and the tapped bulk density TD_{ST} g/cm³ of the mixed powder of porous silica and talc higher than a predetermined value. The tapped bulk density values of porous silica and talc vary, depending on their particle diameter, surface irregularities, sphericity etc. That is also true for the cordierite-forming raw material, and thus the volume ratio of porous silica and talc is the most important factor in determining the degree of tortuosity in the exhaust gas purification filter 1. Hence the degree of tortuosity can be increased by setting PD_{M}/TD_{ST}, which represents the particle number ratio of the mixed powder of porous silica and talc that is the pore forming material, to one of the above predetermined values or higher. The compressed bulk density is measured by a method described hereinafter, referring to a second experimental example.

The average particle size A₁ μm of the porous silica and the average particle size A₂ μm of the Al source preferably satisfy the relationship A₁/A₂≤3.58, or more preferably A₁/A₂≤3.43, or still more preferably A₁/A₂≤3.28. In this case, the degree of tortuosity L/T can be further increased. This is because the packing density of the constituent materials in the cordierite-forming raw material can be controlled by adjusting the particle size ratio between the porous silica, which is a pore forming material, and the Al source, which is a frame forming material. A pore-forming material is a raw material that affects the formation of the pore portions in the partition walls 12, and in the cordierite-forming raw material the pore-forming material is, for example, a Si source such as porous silica or talc. On the other hand, the frame forming material is a raw material that affects the formation of the ceramic portions of the partition walls 12, and in the cordierite forming raw material the frame forming material is, for example, an Al source such as aluminum hydroxide or alumina.

It is preferable to use aluminum hydroxide as an Al source, since that enables the porosity to be increased.

In the manufacture of the exhaust gas purification filter 1, water, a binder, a lubricating oil, and pore forming material, etc., are appropriately mixed with the cordierite forming raw material, to produce a clay that includes the cordierite forming raw material. A kneader can be used for mixing. Subsequently, the clay is molded into a honeycomb shape, for example by extrusion. The molded body made of clay is then cut into predetermined lengths after drying, for example.

The molded body is then fired, to thereby obtain a sintered body having a honeycomb structure. Although not shown in the drawings, the sintered body having a honeycomb structure has the same configuration as the exhaust gas purification filter 1 illustrated in FIGS. 1 and 2, other than in that no sealing portions have been formed.

Sealing portions 16 are then formed, by using a dispenser or printer, etc., to fill the first end surface 14 or the second end surface 15 of the cell 13 with a slurry containing the same kind of ceramic raw material as that of the sintered body having a honeycomb structure, and then baking the sintered body. The method of forming the sealing portions 16 is not specifically limited, and other methods may be used. Alternatively, sealing portions may be formed on the green body before firing, and sintering of the green body and of the sealing portions may be performed concurrently, in a single firing step. Alternatively, the sealing portions may be formed by deforming parts of the partition walls 12 on an end surface of the honeycomb form molded body, before or during firing.

An exhaust gas purification filter 1 having a degree of tortuosity of 1.1 or more can thereby be manufactured, providing a filter with a high capture ratio.

Furthermore, as with the second embodiment, the particle number ratio of the pore-forming material in the mixed powder may be increased, in order to increase the ratio Φ₁/Φ₂ to a predetermined value. The degree of contact between the pore forming materials can thereby be increased, by increasing Φ₁/Φ₂. As a result, an exhaust gas purification filter 1 having a low pressure loss can be obtained, with almost no reduction in the capture ratio.

With the present embodiment, a method of increasing the degree of tortuosity of the pores and increasing the ratio Φ₁/Φ₂ has been described for the case of an exhaust gas purification filter containing cordierite as the main constituent. However the principles of the manufacturing method of the present embodiment are also applicable to an exhaust gas purification filter having a material other than cordierite as its main constituent, for increasing the degree of pore tortuosity and increasing the ratio Φ₁/Φ₂ of the filter. That is to say, even when the main constituent is a material other than cordierite, the degree of tortuosity and the ratio Φ₁/Φ₂ can be increased based on applying the principles of the manufacturing method described for the present embodiment. For example even if the exhaust gas purification filter is mainly formed of a material other than cordierite, the bulk density, particle diameter ratio, etc., of the pore-forming material and the frame-forming material may be adjusted in the same manner as described for the present embodiment. Thus in this case also, an exhaust gas purification filter can be obtained which has a degree of tortuosity and a ratio Φ₁/Φ₂ that are higher than predetermined values.

### First Experimental Example

In this example, a plurality of exhaust gas purification filters 1 having different values of degree of tortuosity and of the ratio Φ₁/Φ₂ were produced, and their PM capture ratios compared and evaluated.

Specifically, porous silica, talc and aluminum hydroxide were blended appropriately, to prepare a cordierite-forming raw material. A pore former made of graphite, water, a lubricant, and a binder made of methyl cellulose was added appropriately to the cordierite-forming raw material, to prepare a clay containing the cordierite-forming raw material. Although in general the kneading time of the clay is made approximately 30 minutes to 2 hours, the kneading time applied for the test pieces, designated as A1 to A3, A6 to A11, and A14 to A17 respectively, was extended in order to improve the connectivity and the degree of tortuosity of the pores, by improving the contact between particles. However, if the kneading time of the clay is made excessively long, the water evaporates and sufficient formability cannot be obtained. Hence with this example, the kneading time of the clay was extended by about 1.2 to 1.5 times. The clay which was thereby produced was extrusion molded and fired, and then sealing portions were formed, to produce an exhaust gas purification filter containing cordierite as a main component.

In this example, seventeen types of exhaust gas purification filter 1 were manufactured, by varying the average particle diameter, the mixing ratio of porous silica, talc and aluminum hydroxide, the mixing ratio of graphite, etc. These exhaust gas purification filters are referred to as test bodies A1 to A6, A8 to A12, and A14 to A19 in the following.

The porosity, average pore size, degree of tortuosity L/T and ratio Φ₁/Φ₂ of each test body were measured, and the results are shown in Table 1. The capture ratio and pressure loss of each test body were also measured, and the results are shown in Table 1. In addition the degree of tortuosity L/T and capture ratio of each test body, after 60 g/L of catalyst had been charged in the pores, were measured, with the results shown in Table 1. An in-wall coating method was used to support the catalyst, in which a catalyst-containing slurry is filled between the partition walls of each test body and the catalyst-containing slurry is then drawn out from one end surface or from both end surfaces of the test body.

(Porosity and Average Pore Diameter)

The porosity and the average pore diameter 22 in the partition wall 12 of each test body were measured by a mercury porosimeter, using the principle of mercury intrusion method. The AutoPore IV9500 manufactured by the Shimadzu Corporation (Micrometrics company) was used as the mercury porosimeter. The measurement conditions were as follows.

First, test pieces for measurement were cut out from each test body. Each test piece is a rectangular parallelepiped whose dimensions in the directions orthogonal to the axial direction are 15 mm long×15 mm wide and whose axial length is 20 mm. Next, the test piece was placed in the measurement cell of the mercury porosimeter, and the pressure in the measurement cell was reduced. Mercury was subsequently introduced into the measurement cell and subjected to pressure, and the pore size and pore volume were then measured, by using the value of pressure at the time of pressurization and the volume of mercury that entered the pores of the test piece.

The measurement was performed in a pressure range of 0.5 to 20,000 PSIA. 0.5 PSIA corresponds to 0.35×10⁻³ kg/mm² and 20,000 PSIA corresponds to 14 kg/mm². The range of pore diameters corresponding to this pressure range is 0.01 to 420 μm. A contact angle of 140° and a surface tension of 480 dyn/cm were used as constants for calculating the pore diameter from the pressure. The average pore diameter Φ₂ is the pore diameter at an integrated value of 50% of the pore volume. The porosity was calculated from the following relationship expression, where the true specific gravity of cordierite is 2.52:

Porosity (%)=total pore volume/(total pore volume+1/true specific gravity of cordierite)×100

(Degree of Tortuosity)

The degree of tortuosity of the pores in the partition walls 12 of each test body was measured by the method described for the first embodiment. ImageJ version 1.46 image analysis software, manufactured by the United States National Institutes of Health (NIH), was used to perform binarization. GeoDict version 2017 analysis software manufactured by the SCSK company was used for measurement of the flow path length when calculating the degree of tortuosity.

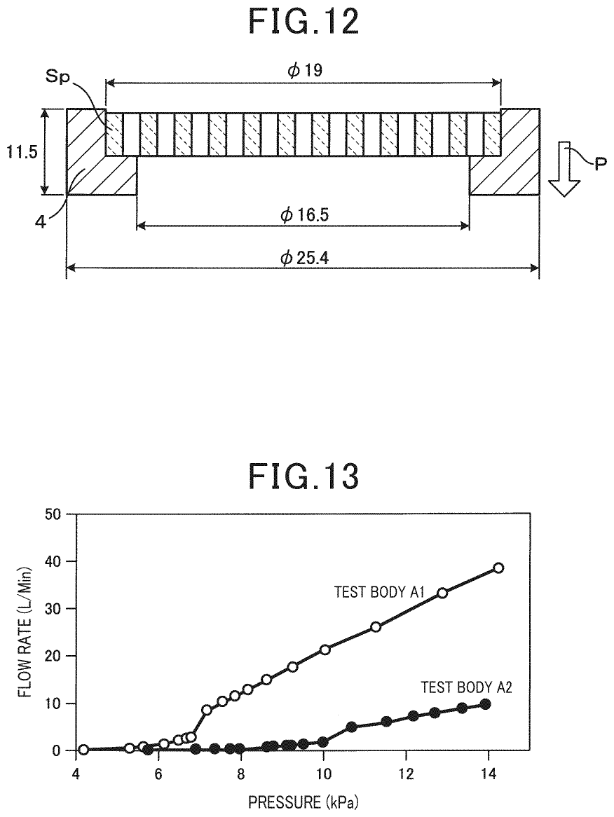

(The Ratio Φ₁/Φ₂) The average neck diameter Φ₁ of the communicating pores 122 in each test body was measured according to the method described for the second embodiment. The bubble point method was applied using a CEP-1100AXSHJ measurement apparatus manufactured by the Porous Materials company. In the measurement, a ring-shaped jig 4 having an outer diameter of 25.4 mm and an inner diameter of 16.5 mm, illustrated in FIG. 12, was used. The jig 4 is provided with a recess having an inner diameter Φ of 19 mm, in which the measurement sample Sp was placed. The measurement sample Sp was a disk-like body having a diameter Φ of 19 mm and a thickness of 400 to 500 μm, and was cut out from each test body as described for the second embodiment. The measurement sample Sp was cut out such that the diameter direction of the discoid body is at right angles to the axial direction Y of the test body and the thickness direction of the discoid body is the same as the axial direction Y of the test body. The surface of the measurement sample Sp cut out of the test body was finish-polished with #320 sandpaper, and a non-air-permeable plastic paraffin film was then attached to both end surfaces of the measurement sample Sp. By forming holes in each film, the openings of first cells 131 and of second cells 132 were formed, while parts of the film in which no holes were formed served as the sealing portions 16 of the first cells 131 and second cells 132. It should be noted that the film and sealing portions 16 are omitted from FIG. 12, for simplicity. The measurement sample Second period, provided with sealing portions 16, was disposed in the recess of the jig 4. Silwich, manufactured by the Porous Materials company, was used as the liquid which was impregnated into the measurement sample Sp by the bubble point method, with the surface tension adjusted to 20.1 dynes/cm. This liquid was dropped, using a 2 ml syringe, until the measurement sample Sp was covered, and vacuum degassing was performed until the liquid was completely impregnated. Gas under pressure was subsequently applied in the thickness direction of the measurement sample Sp, and the relationship between pressure and gas flow rate was examined. The direction in which the pressure was applied is indicated by the arrow P in FIG. 12. The first cells 131 were open at the end surface of the measurement sample Sp where the pressure is applied, while the second cells 132 were open at the end surface of the measurement sample Sp opposite the end surface where the pressure is applied.

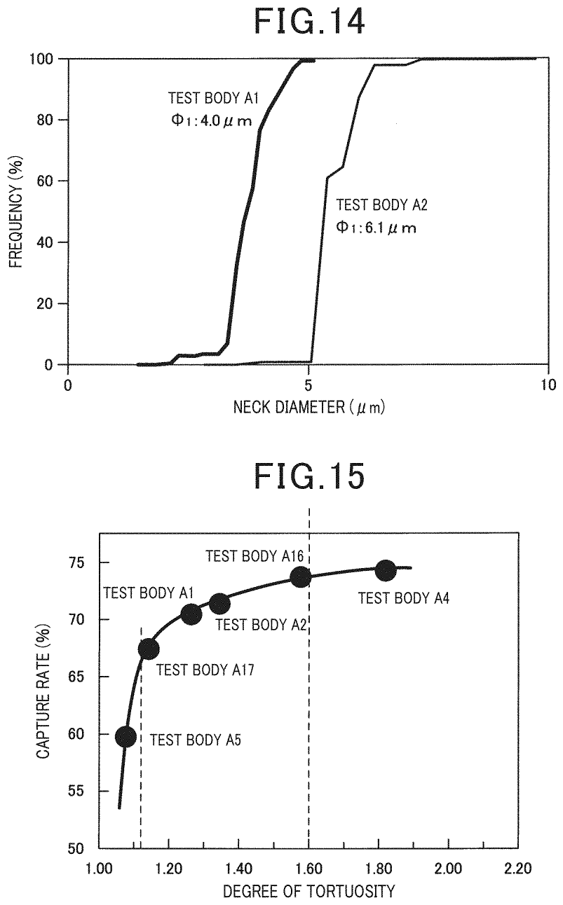

Pressure curves expressing relationships between pressure and flow rate with the bubble point method are shown in FIG. 13, specifically, the pressure curves obtained for test body A1 and test body A2. Furthermore by measuring the pore diameter (that is, the neck diameter) at each pressure from the pressure curve, based on the equation (4) of the second embodiment, the relationships between neck diameter and accumulation frequency shown in FIG. 14 can be obtained. The neck diameter at a frequency of 50% in this relationship diagram is the value of neck diameter of the measurement sample Sp. Moreover as described for the second embodiment, six measurement samples Sp were collected from each test body, and the neck diameter of each measurement sample Sp was measured. The average value of these neck diameters was then calculated, and the ratio Φ₁/Φ₂ of the values of the average neck diameter Φ₁ to the above-described average pore diameter Φ₂ was calculated.

(Capture Ratio and Pressure Loss)

The PM capture ratio and the pressure drop were measured as follows. The exhaust gas purification filter 1 of each test body was attached to the exhaust pipe of a direct injection gasoline engine, and a flow of exhaust gas containing PM was passed to the filter. At this time, the PM number in the exhaust gas before the gas passed into the exhaust gas purification filter 1, and the PM number in the exhaust gas flowing out from the filter, were respectively measured for calculating the PM capture ratio. The measurement conditions were a temperature of 450° C. and an exhaust gas flow rate of 2.8 m³/min. The pressure of the exhaust gas before entering the exhaust gas purification filter and the pressure after exiting from the filter were respectively measured by pressure sensors, concurrently with measuring the capture ratio, and the pressure loss of the exhaust gas purification filter was measured as the difference between the respective pressure values obtained. The measurement conditions in this case were a temperature of 720° C. and an exhaust gas flow rate of 11.0 m³/min. All of the measurements were performed commencing from an initial state in which no PM was deposited in the exhaust gas purification filter. The PM number was measured using a PM particle number counter (AVL-489) manufactured by AVL.

TABLE 1

| | | | | | | | After | |
|---|---|---|---|---|---|---|---|---|
| | | Average | | | | | supporting catalyst | |
| | | pore | Tortuosity | | | | Tortuosity | |
| | Porosity | sizeΦ₂ | degree L/T | Φ₁/Φ₂ | Capture | Pressure | degree L/T | Capture |
| Sample No. | [%] | [um] | [—] | [—] | ratio [%] | loss [kPa] | [—] | ratio [%] |
| Test body | 65 | 18 | 1.26 | 0.22 | 71 | 5.6 | 1.94 | 61 |
| A1 | | | | | | | | |
| Test body | 65 | 18 | 1.34 | 0.34 | 72 | 5.9 | 2.06 | 62 |
| A2 | | | | | | | | |
| Test body | 65 | 18 | 1.23 | 0.42 | 71 | 3.9 | 1.89 | 62 |
| A3 | | | | | | | | |
| Test body | 65 | 18 | 1.82 | 0.23 | 74 | 7.3 | 2.80 | 65 |
| A4 | | | | | | | | |
| Test body | 65 | 18 | 1.07 | 0.40 | 60 | 4.7 | 1.65 | 50 |
| A5 | | | | | | | | |
| Test body | 63 | 18 | 1.30 | 0.72 | 70 | 5.0 | 2.00 | 60 |
| A6 | | | | | | | | |
| Test body | 64 | 18 | 1.25 | 0.17 | 68 | 8.8 | 1.93 | 58 |
| A8 | | | | | | | | |
| Test body | 65 | 9 | 1.33 | 0.22 | 75 | 12.0 | 2.05 | 66 |
| A9 | | | | | | | | |
| Test body | 65 | 34 | 1.33 | 0.22 | 52 | 2.8 | 2.05 | 42 |
| A10 | | | | | | | | |
| Test body | 40 | 18 | 1.32 | 0.22 | 53 | 18.6 | 2.03 | 43 |
| A11 | | | | | | | | |
| Test body | 80 | 18 | 1.05 | 0.83 | 73 | 2.9 | 1.62 | 63 |
| A12 | | | | | | | | |
| Test body | 65 | 14 | 1.23 | 0.43 | 83 | 6.1 | 1.89 | 73 |
| A14 | | | | | | | | |
| Test body | 80 | 18 | 1.34 | 0.33 | 75 | 2.9 | 2.06 | 65 |
| A15 | | | | | | | | |
| Test body | 65 | 18 | 1.59 | 0.24 | 74 | 6.8 | 2.45 | 63 |
| A16 | | | | | | | | |
| Test body | 65 | 18 | 1.15 | 0.23 | 68 | 5.1 | 1.77 | 58 |
| A17 | | | | | | | | |
| Test body | 64 | 18 | 1.24 | 0.19 | 69 | 6.6 | 1.91 | 59 |
| A18 | | | | | | | | |
| Test body | 64 | 18 | 1.26 | 0.50 | 75 | 4.5 | 1.94 | 64 |
| A19 | | | | | | | | |

As shown in Table 1, an exhaust gas purification filter 1 having a degree of tortuosity of 1.1 or more has a high capture ratio. To illustrate the trend of the relationship between the degree of tortuosity and the capture ratio, the relationship is shown in FIG. 15 for the test samples. As shown by FIG. 15, when the degree of tortuosity is increased, the capture ratio is increased, and at a degree of tortuosity of 1.1 or more, a high capture ratio of greater than 65% is exhibited. If the degree of tortuosity is 1.2 or more, the capture ratio exceeds 70%. It is considered that this is because the frequency of collisions of PM with the wall surfaces due to Brownian motion rises, and the frequency of inertial collision of PM also rises, as the degree of tortuosity increases and the flow path of the communicating pores in the partition walls becomes more complex.

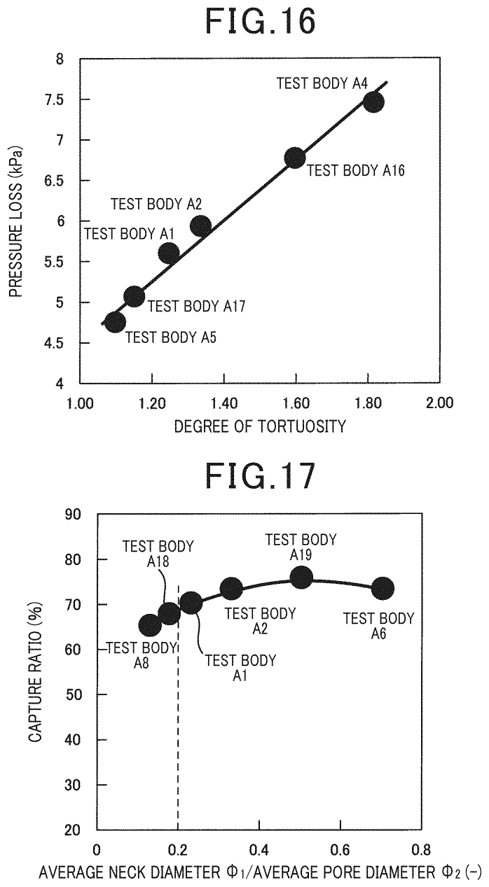

On the other hand, if the tortuosity exceeds 1.6, the ratio of increase of the capture ratio is greatly reduced. The reason for this is that the more complex the flow path through the communicating pores, the more numerous become the intersections of the flow paths, and while the frequency of collision with the partition walls due to Brownian motion increases, branching of the flow paths through which PM passes becomes increased. It can be considered that these factors result in reducing of collisions due to PM inertia. Furthermore as shown in FIG. 16, the degree of tortuosity and the pressure loss have a proportional relationship, with the pressure loss increasing as the degree of tortuosity increases. It can thus be understood that the tortuosity is preferably made no greater than 1.6, since higher values will have hardly any effect in improving the capture ratio and will increase the pressure loss.

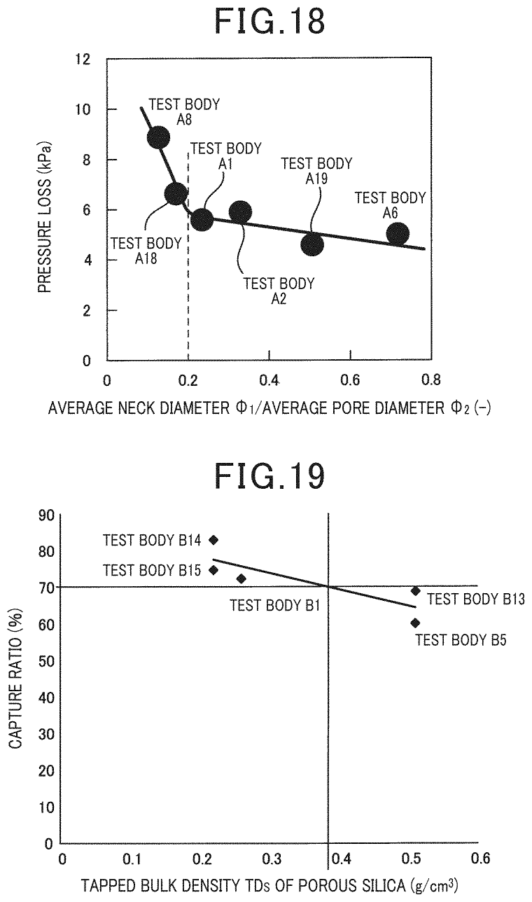

Furthermore as shown by Table 1, if the ratio Φ₁/Φ₂ of the average neck diameter to the average pore diameter is increased, the pressure loss becomes decreased, with almost no decrease in the capture ratio. To illustrate the trends of the relationship between Φ₁/Φ₂ and the capture ratio, and between Φ₁/Φ₂ and the pressure loss, the relationship between Φ₁/Φ₂ and the capture ratio of the test bodies is shown in FIG. 17, while the relationship between Φ₁/Φ₂ and the pressure loss of the test bodies is shown in FIG. 18.

As shown by FIGS. 17 and 18, the pressure loss can be reduced by increasing the ratio Φ₁/Φ₂, with almost no change in the capture ratio. In particular, by setting Φ₁/Φ₂ to 0.2 or more, the pressure loss can be significantly reduced without causing a significant change in the capture ratio. Generally, increasing the average pore diameter is used as method of suppressing pressure loss. However in the case of the communicating pores, widening of neck portions of the pores, which constitute bottlenecks, is particularly effective. Specifically, an effective reduction in the pressure loss can be achieved by increasing the ratio Φ₁/Φ₂ of the average neck diameter to the average pore diameter, and in particular, a significant effect in reducing the pressure loss can be achieved by setting Φ₁/Φ₂ to 0.2 or more

Furthermore, by making the ratio Φ₁/Φ₂ 0.2 or more and also making the degree of tortuosity 1.1 or more, an excellent trade-off can be made between achieving a high capture ratio and maintaining a low amount of pressure loss.

The relationships between flow path shape factors such as the degree of tortuosity and the ratio Φ₁/Φ₂ and the capture ratio and pressure loss have been demonstrated by this example, and it can be said that similar relationships exist for exhaust gas purification filters having a material other than cordierite as their main constituent. That is to say, the same effects as for this example can be obtained by similarly adjusting the degree of tortuosity and the ratio Φ₁/Φ₂, when the main constituent of an exhaust gas purification filter 1 is a material such as aluminosilicate, having as its main components SiC, ceria-zirconia and mullite.

### Second Experimental Example

With this example, a method of manufacturing an exhaust gas purification filter having a high degree of tortuosity will be examined. When the exhaust gas purification filter is to contain cordierite as a main component, a cordierite forming raw material that includes a Si source, an Al source and an Mg source is used to produce a cordierite composition. A mixture that appropriately combines porous silica, talc, aluminum hydroxide, alumina, kaolin, etc., can be used as the cordierite forming raw material. In the manufacture of the exhaust gas purification filter 1, water, a binder, a lubricating oil, and a pore former, etc., are appropriately mixed with the cordierite forming raw material, to prepare a clay that includes the cordierite forming raw material. The exhaust gas purification filter is then obtained by performing steps of extrusion molding of the clay, firing, formation of sealing portions, etc., as described for first experimental example.

Porous silica and talc can be melted at high temperature to form pores 121, and thus can be called pore forming materials. The higher the particle number ratio of the pore forming material, the better becomes the contact between particles, and the degree of tortuosity can thereby be increased. Hence if a clay containing the cordierite-forming raw material is extrusion-formed, the particle number ratio of porous silica to talc contained in the clay may be controlled such as to increase the degree of tortuosity.

However, the particle number ratio is difficult to measure, and it can be assumed that the measured value will vary depending on the molding conditions. Hence it is desirable to employ an index that can be used to adjust the degree of tortuosity by controlling the conditions of powdered raw materials such as silica, talc, and Al source. In view of this, the following examination was conducted focusing on the tapped bulk density of porous silica, the compressed bulk density of the cordierite forming raw material powder, etc.

A clay having the specific composition shown in Table 2 will be considered. As shown in Table 2, the cordierite-forming raw material is prepared by appropriately blending porous silica, talc and aluminum hydroxide. Three types of silica having respectively different values of tapped bulk density were used as the porous silica. The tapped bulk densities of these porous silicas, shown in Table 3, were measured as follows.

(Tapped Bulk Density)

The measurement of tapped bulk density was performed using a tapped bulk density flow adhesion measuring device, specifically, a Tap Denser manufactured by Seishin Enterprise Co., Ltd. The powder to be measured was filled in the cylinder of the measuring device and was then compressed by tapping, and the bulk density was calculated from the mass of the powder in the compressed state and the volume of the cylinder. That bulk density is the tapped bulk density. Porous silica, or a mixed powder of porous silica and talc, were used as the powder to be measured.

One type of aluminum hydroxide, or two types having respectively different average particle sizes, were used. A pore-forming material made of graphite, water, a lubricating oil, and a binder made of methyl cellulose were appropriately added to the cordierite-forming raw material. It can be considered that a clay is produced from mixing such raw materials. A kneading time of about 30 minutes to 2 hours would generally be applied for the test pieces B14 and B15, however the kneading time was lengthened in order to increase the connectivity and the degree of tortuosity, by improving contact between the particles. Nevertheless, if the kneading time of the clay is too long the water will evaporate, so that sufficient formability cannot be obtained. Hence with this example the kneading time of the clay was extended by about 1.2 to 1.5 times.

TABLE 2

| | | Test Body | Test Body | Test Body | Test Body | Test Body |
|---|---|---|---|---|---|---|
| Sample No. | | B5 | B14 | B1 | B15 | B13 |
| Porous | Average particle | 21 | 16 | 21 | 16 | 21 |
| silica | size [μm] | | | | | |
| | Blending | 20.5 | 20.5 | 20.5 | 20.5 | 20.5 |
| | ratio [wt %] | | | | | |
| Talc | Average particle | 35 | 14 | 20 | 20 | 35 |
| | size [μm] | | | | | |
| | Blending | 35.3 | 35.3 | 35.3 | 35.3 | 35.3 |
| | ratio [wt %] | | | | | |
| Aluminum | Average particle | 5 | 3 | 3 | 3 | 5 |
| hydroxide A | size [μm] | | | | | |
| | Blending | 44.2 | 13.3 | 13.3 | 22.1 | 44.2 |
| | ratio [wt %] | | | | | |
| Aluminum | Average particle | — | 8 | 8 | 8 | — |
| hydroxide B | size [μm] | | | | | |
| | Blending | 0 | 30.9 | 30.9 | 22.1 | 0 |
| | ratio [wt %] | | | | | |
| Methyl | Blending | 9 | 9 | 9 | 9 | 9 |
| cellulose | ratio [wt %] | | | | | |
| Graphite | Average particle | 25 | — | — | — | — |
| | size [μm] | | | | | |
| | Blending | 20 | 0 | 0 | 0 | 0 |
| | ratio [wt %] | | | | | |
| Lubricating | Blending | 5.5 | 5.5 | 5.5 | 5.5 | 5.5 |
| oil | ratio [wt %] | | | | | |
| Water | Blending | 46 | 34 | 34 | 66 | 45 |
| | ratio [wt %] | | | | | |

The compressed bulk density of the cordierite-forming raw material powder (hereinafter referred to as the mixed powder) was measured in order to examine an evaluation method which simulates clay. Specifically, the mixed powder was first loaded into an “Autograph” pressure measuring instrument manufactured by Shimadzu Corporation, having a diameter of 25 mm and a length of 20 mm, and compressing of the mixed powder was started. The compression speed was 1 mm/min. The compressing was halted by limit control when a load of 7 kN, corresponding to an actual molding pressure of 15 MPa, was reached. Cylindrical pellets composed of the mixed powder were obtained by this compressing. The weight and height of the pellet were measured.

The measurement of the height of a pellet can be performed using a caliper, a micrometer, a three-dimension measurement machine or the like. In this case the measurement was performed using a micrometer. Since the diameter of the pellet is 25 mm, the volume of the pellet was calculated as the product of the diameter and the height.

The density was calculated, from the volume and weight of the pellet, i.e., by dividing the weight by the volume. This density was taken as the compressed bulk density. Methylcellulose “65 MP-4000” manufactured by Matsumoto Yushi-Seiyaku Co., Ltd. was added to the mixed powder as a binder. The binder serves to facilitate handling of the pellet-like mixed powder. It would be equally possible to use another binder. Specifically, 1.5 g of mixed powder and 0.5 g of binder, making a total of 2 g, was used.

In general, there is a correlation between the particle size and the bulk density, and the smaller the particle size the smaller is the bulk density, since spaces are formed between the particles. The number of particles disposed in a certain volume increases as the particle diameter decreases. Hence the smaller the bulk density, the larger is the number of particles, i.e., the bulk density and the number of particles are in inverse proportion to each other.

The particle number ratio R of the pore-forming material in the mixed powder is calculated using the following equation (i), from the particle number N_{ST} of porous silica and talc alone and the particle number N_{M} of all the raw material mixed powders used in the production of the exhaust gas purification filter. The pore-forming material was porous silica and talc.

R=N_{ST}/N_{M} (i)

Applying the above relationship between bulk density and particle number to formula (i), the particle number ratio R of the pore-forming material is expressed by the following equation (ii), from the bulk density D_{M} of all of the raw material, i.e., of the mixed powders of porous silica, talc, and aluminum hydroxide, and the bulk density D_{ST} of porous silica and talc:

R=D_{M}/D_{ST} (ii)

That is, as shown by equation (ii), the particle number ratio increases in accordance with increase of the bulk density of aluminum hydroxide, and in accordance with decrease of the bulk density of porous silica and talc. In this example, the tapped bulk density TD_{S} of porous silica is used as the bulk density D_{S} of the porous silica, the tapped density TD_{ST} of the mixed powder of porous silica and the talc is used as the bulk density D_{ST} of the mixed powder of porous silica and talc, and the compressed bulk density PD_{M} of the cordierite forming raw material is used as the bulk density D_{M} of the cordierite forming raw material.

Values of tapped bulk density TD_{S} of porous silica, tapped bulk density TD_{ST} of mixed powder of porous silica and talc, and compressed bulk density PD_{M} of cordierite-forming raw material were measured for the clays shown in Table. The tapped bulk density TD_{S} and the compressed bulk density PD_{M} were measured by the method described above. The results are shown in Table 3.

The exhaust gas purification filter 1 of each test body was obtained by performing extrusion molding, baking, and formation of sealing portions in a similar manner to experimental example 1, using each of the clays shown in Table 2. The degree of tortuosity L/T, the ratio Φ₁/Φ₂ of average neck diameter to average pore diameter, the capture ratio, and the pressure loss of each test body were measured in the same manner as for first experimental example. The results obtained are shown in Table 3. The test bodies B1, B5, B14 and B15 are from the same exhaust gas purification filter 1 as the test bodies A1, A5, A14 and A15 of experimental example 1, respectively. The test body B13 is an exhaust gas purification filter having a degree of tortuosity of 1.12, manufactured for this example.

TABLE 3

| | Sample No. | | | | |
|---|---|---|---|---|---|
| | | Test body | | Test body | Test body |
| | Test body B5 | B14 | Test body B1 | B15 | B13 |
| Type of porous silica | Porous silica A | Porous silica B | Porous silica C | Porous silica B | Porous silica A |
| Tapped bulk density of | 0.51 | 0.22 | 0.26 | 0.22 | 0.51 |
| porous silica TD_{S} | | | | | |
| [g/cm³] | | | | | |
| Tapped bulk density of | 0.91 | 0.76 | 0.79 | 0.79 | 0.91 |
| mixed powder of | | | | | |
| porous silica and talc | | | | | |
| TD_{ST} | | | | | |
| [g/cm³] | | | | | |
| Compressed bulk | 1.42 | 1.56 | 1.56 | 1.56 | 1.42 |
| density of cordierite- | | | | | |
| forming agent PD_{M} | | | | | |
| [g/cm³] | | | | | |
| PD_{M}/TD_{ST} | 1.56 | 2.05 | 1.97 | 1.97 | 1.56 |
| Average particle size of | 4.2 | 2.5 | 3.2 | 2.9 | 4.2 |
| porous silica A₁/ | | | | | |
| average particle size of | | | | | |
| aluminum hydroxide A₂ | | | | | |
| Degree of tortuosity | 1.07 | 1.23 | 1.26 | 1.34 | 1.12 |
| L/T | | | | | |
| Average neck diameter | 0.4 | 0.42 | 0.22 | 0.34 | 3 |
| Φ₁/average pore | | | | | |
| diameter Φ₂ | | | | | |
| Capture ratio [%] | 60.2 | 83 | 72.3 | 74.6 | 69 |
| Pressure loss [kPa] | 4.7 | 6.1 | 5.6 | 5.9 | 6.6 |

As can be seen from Table 3, by using porous silica B and porous silica C having a small tapped bulk density TD_{S}, the particle number ratio of the porous silica and talc becomes increased, where that particle number ratio is expressed by the ratio PD_{M}/TD_{ST} of the pressurized bulk density PD_{M} of the cordierite-forming raw material to the tapped bulk density TD_{ST} of the mixed powder of porous silica and talc. In addition, the bulk density of aluminum hydroxide can be increased and the filling property improved by using a mixture of aluminum hydroxide having a relatively large average particle size and aluminum hydroxide having a relatively small average particle size.

In general, by setting the proportion of aluminum hydroxide having a small average particle size to 25 wt % to 30 wt % of the total amount of aluminum hydroxide, the filling property is further improved. However, the optimum combining ratio for enhancing the filling property will vary depending on the combination of particle sizes, particle shape, distribution, etc.

With this experimental example, as shown in Tables 2 and 3, aluminum hydroxide having an average particle size of 5 μm alone was used as the aluminum hydroxide in the test bodies B5 and B13, while aluminum hydroxide having a ratio of small particle size to large particle size of 3:7 (small particle size:large particle size) was used in the test specimens B1 and B14, and aluminum hydroxide having a ratio of small particle size to large particle size of 5:5 was used in the test body B15. As a result, as can be seen from Table 3, for blending proportions of 30 wt % to 50 wt % of small size particles, the values of bulk density of the cordierite-forming raw material are of a similar order.

Furthermore as shown by Table 3, the ratio PD_{M}/TD_{ST} between the compressed bulk density PD_{M} of the cordierite-forming raw material and the tapped bulk density TD_{ST} of the mixed powder of porous silica and talc, which is the pore forming material, sequentially increases in the order of the test specimens B5 and B13, the test specimens B1 and B15, and the test specimen B14. That ranking order of PD_{M}/TD_{ST} is approximately correlated with the ranking order of degrees of tortuosity L/T and the ranking order of capture ratios. It can thus be understood that by reducing the tapped bulk density of the porous silica and increasing the ratio PD_{M}/TD_{ST}, the degree of tortuosity, and hence the capture ratio, can be increased.

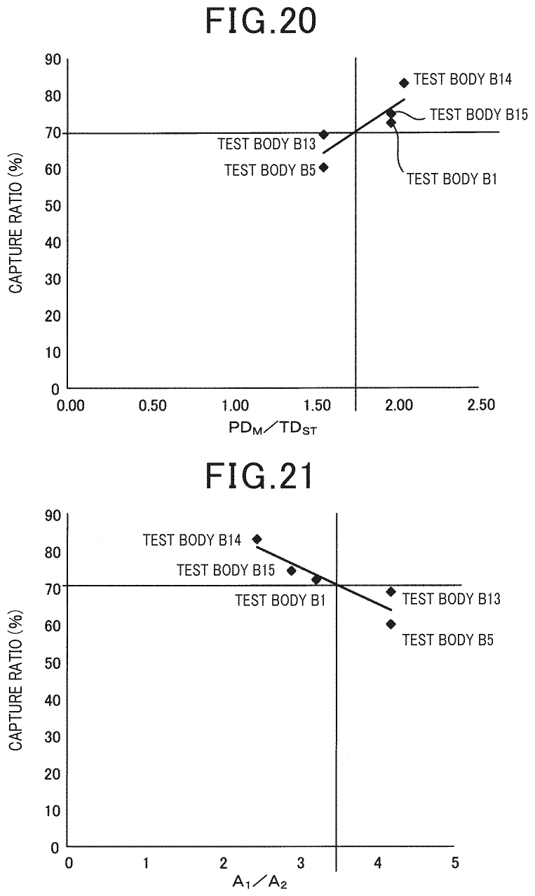

FIG. 19 shows the relationship between the tapped bulk density TD_{S} of porous silica and the capture ratio. FIG. 20 shows the relationship between the ratio PD_{M}/TD_{ST} and the capture ratio. FIG. 21 shows the relationship between the ratio A₁/A₂ of the average particle diameter A₁ of porous silica to the average particle diameter A₂ of aluminum hydroxide and the capture ratio.

As can be understood from FIG. 19, the capture ratio can be made 70% or more by using porous silica with a tapped bulk density of 0.38 g/cm³ or less. Furthermore as can be understood from FIG. 20, capture ratio can be made 70% or more by setting the ratio PD_{M}/TD_{ST} to 1.7 or more. Moreover as can be understood from FIG. 21, the capture ratio can be made 70% or more by setting the ratio A₁/A₂ to 3.58 or less.

In this example, silica, talc, and alumina hydroxide were used as cordierite-forming raw materials, however the cordierite-forming raw materials may include raw materials such as kaolin and alumina. In addition, if it is permissible to achieve a lower porosity, then alumina may be used as an Al source. Specifically, aluminum hydroxide or alumina, or both of these, may be used an Al source. The aluminum hydroxide and alumina may have the same average particle size or may have different average particle sizes. The proportions of these may be appropriately adjusted, from the aspects of moldability, shrinkability, cost, etc.

The technique of the present disclosure is not limited to the above embodiments and experimental examples, and various modifications may be made without departing from the scope of the disclosure. Furthermore the configurations illustrated by respective embodiments and experimental examples may be arbitrarily combined.

What is claimed is:

1. An exhaust gas purification filter comprising:
a casing; and
porous partition walls that partition the interior of the casing into a plurality of cells,
wherein the partition walls have a plurality of communicating pores that communicate between cells which are adjacent to respective partition walls,
and wherein a degree of tortuosity L/T, defined by the ratio of the average path length L μm of the communicating pores to the thickness T μm of the partition walls, satisfies the following equation (1):
L/T≥1.1 (1)

2. The exhaust gas purification filter according to claim 1, wherein the degree of tortuosity L/T further satisfies the following equation (2):
L/T≤1.6 (2)

3. The exhaust gas purification filter according to claim 1, wherein an average value of neck diameter Φ₁ μm and an average pore diameter Φ₂ μm in the partition walls satisfy the following equation (3), where the average value of neck diameter Φ₁ μm is defined by the average of respective equivalent circle diameters of neck portions having the smallest flow path areas in the communicating pores:
Φ₁/Φ₂≥0.2 (3)

4. The exhaust gas purification filter according to claim 1, wherein the porosity of the partition walls is greater than or equal to 55% and less than or equal to 75% and the average pore diameter is greater than or equal to 12 μm and less than or equal to 30 μm.

5. The exhaust gas purification filter according to claim 1, wherein the capture ratio of particulate matter by the exhaust gas purification filter is greater than or equal to 70%.

6. The exhaust gas purification filter according to claim 1, wherein a catalyst of more than or equal to 50 g/L is supported, and in that the degree of tortuosity L/T is greater than or equal to 1.6 and less than or equal to 2.5.

7. A method of manufacturing an exhaust gas purification filter, comprising:
a mixing step of mixing porous silica having a tapped bulk density that is less than or equal to 0.38 g/cm³, talc, and an aluminum source, to prepare a cordierite forming raw material;
a molding step of preparing a clay that includes the cordierite forming raw material, and molding the clay to prepare a molded body; and
a firing step of firing the molded body.

8. A method of manufacturing an exhaust gas purification filter according to claim 7, wherein in the mixing step, a cordierite forming raw material is prepared which satisfies PD_{M}/TD_{ST}≥1.7, where PD_{M} g/cm³ is the compressed bulk density of the cordierite forming raw material and TD_{ST} g/cm³ is the tapped bulk density of mixed powders of the porous silica and the talc.

9. A method of manufacturing an exhaust gas purification filter according to claim 7, wherein a relationship A₁/A₂≤3.58 is satisfied, where A₁ μm is the average particle size of the porous silica and A₂ μm is the average particle size of the aluminum source.
